(19) United States
(12) Patent Application Publication
(10) Pub. No.: US 2018/0364800 A1
(43) Pub. Date: Dec. 20, 2018

(54) System for Picking an Object Base on View-Direction and Method Thereof

(71) Applicant: FXGEAR INC., Seoul (KR)

(72) Inventors: Kyung Kun NA, Seoul (KR); Kwang Jin CHOI, Seongnam-si (KR)

(21) Appl. No.: 15/633,683

(22) Filed: Jun. 26, 2017

(30) Foreign Application Priority Data
Jun. 14, 2017 (KR) 10-2017-0074875

(51) Int. Cl. G06F 3/01; G06T 15/20; G06F 3/0484; G06F 3/0481; B25J 9/16; G06T 19/20

(52) U.S. Cl. CPC G06F 3/011; G06T 15/205; G06T 19/20; G06F 3/04815; B25J 9/1697; G06F 3/04842

(57) ABSTRACT

Exemplary embodiments relate to a system for picking an object based on view-direction including a transmitting device configured to extract an object region including an object from an original image, and transmit an object masking image of the extracted object region and the original image, and a playing device configured to receive the object masking image and the original image from the transmitting device, display the original image, and pick the object in the displayed original image based on view-direction of a user viewing the original image, and a method for picking an object based on view-direction through them. According to the present disclosure, it is possible to overcome the limit of decoding of conventional virtual reality devices and enable picking in an image with ultra high resolution.

### CROSS-REFERENCE TO RELATED APPLICATION

This application claims priority to Korean Patent Application No. 10-2017-0074875, filed on Jun. 14, 2017, and all the benefits accruing therefrom under 35 U.S.C. § 119, the contents of which in its entirety are herein incorporated by reference.

### BACKGROUND

### 1. Field

Exemplary embodiments relate to a system and method for picking an object in an image, and more particularly, to a picking system and method based on a user's view-direction.

### 2. Description of the Related Art

Recently, with the development of various types of display devices, there is a growing users' demand for enhanced realistic and stereoscopic images through display devices. In keeping with the demand, display device manufacturers modify image content processing schemes to provide stereoscopic images, or connect various additional means to image providing devices to provide so realistic images that users find it difficult to distinguish between real and virtual images. For example, there is technology to provide stereoscopic images by simultaneously displaying images captured at different angles using the binocular disparity, or to provide images in a panorama format, covering the entire field of view of a user, to give effects whereby users feel as if they participate in a real environment of the images.

Furthermore, there is technology to pick objects in an image while displaying the image to enable users to identify and control the objects. However, conventional object picking is a large burden on image processing due to identifying and picking objects from an original image itself.

Particularly, most of currently available virtual reality (VR) devices are based on the use of mobile devices such as smartphones, and the maximum resolution supported by hardware accelerated decoding in VR devices is at the level of 4k, but when picking is performed while 4k videos are being played, very serious video lag occurs or the image quality should be reduced.

### SUMMARY

To solve the aforementioned problem, there is a need for a system, device, and method for enabling object picking using a masking image of the object in lower quality than an original image.

The object of the present disclosure is not limited to those mentioned above, and another object not mentioned herein will be clearly understood by those skilled in the art from the following description.

A system for picking an object based on view-direction according to an exemplary embodiment of the present disclosure includes a transmitting device configured to extract an object region including an object from an original image, and transmit an object masking image of the extracted object region and the original image, and a playing device configured to receive the object masking image and the original image from the transmitting device, display the original image, and pick the object in the displayed original image based on view-direction of a user viewing the original image.

In an exemplary embodiment, the transmitting device may be configured to further extract coordinate information of the object region in the original image, and the playing device may be configured to receive the coordinate information from the transmitting device, and pick the object in the displayed original image based on the user's view-direction and the coordinate information.

In an exemplary embodiment, the object masking image may be an image in which the object is separated from a background, and which has lower resolution than the original image.

A device for transmitting an image in which an object can be picked based on view-direction according to an exemplary embodiment of the present disclosure includes an object masking image generating unit configured to extract an object region including an object from an original image, and generate an object masking image of the extracted object region, a coordinate information extracting unit configured to extract coordinate information of the object region in the original image, and a transmitting unit configured to provide a playing device with the original image, the object masking image, and the coordinate information.

In an exemplary embodiment, the device for transmitting an image in which an object can be picked based on view-direction may further include a sprite image generating unit configured to 1) generate a sprite image in which at least two object masking images are combined, when multiple object masking images are included in the original image, or 2) to generate a sprite image in which object masking images for a same object included in each original image are combined, when the original image is continuous multiple images, and the transmitting unit may be configured to provide the playing device with the sprite image.

In an exemplary embodiment, the object masking image may be an image in which the object is separated from a background, and which has lower resolution than the original image.

In an exemplary embodiment, the device for transmitting an image in which an object can be picked based on view-direction may further include a calculating unit configured to calculate a change value of the object region in a current original image by comparing an original image of a previous frame with an original image of a current frame, and the transmitting unit may be configured to transmit, to the playing device, the change value in place of or together with the coordinate information, and the change value may be associated with at least one of translation, scale, and rotation of the object region.

A device for playing an image in which an object can be picked based on view-direction according to an exemplary embodiment of the present disclosure includes a receiving unit configured to receive an original image, an object masking image of at least one object region included in the original image and coordinate information of the object region in the original image, a displaying unit configured to display the received original image, a view-direction detecting unit configured to detect view-direction of a user viewing the displayed original image, and an object picking unit configured to pick the object in the displayed original image based on the detected user's view-direction, the coordinate information, and the object masking image.

In an exemplary embodiment, when the detected user's view-direction faces toward the object in the displayed original image or its surrounding, the object picking unit may be configured to pick the object by comparing the object directed from the user's view-direction with the object masking image.

In an exemplary embodiment, the object picking unit may be configured to calculate texture coordinate information of the object region on a coordinate system in virtual space corresponding to the original image based on the coordinate information, and pick the object based on the calculated texture coordinate information.

In an exemplary embodiment, the device for playing an image in which an object can be picked based on view-direction may further include a calculating unit configured to calculate a change value of the object region in a current original image by comparing an original image of a previous frame with an original image of a current frame, and the change value may be associated with at least one of translation, scale, and rotation of the object region, and the object picking unit may be configured to correct the coordinate information of the object region based on the change value.

In an exemplary embodiment, the original image and the object masking image may be synchronized in time.

In an exemplary embodiment, when the detected user's view-direction is positioned in the object region or within a predetermined range therefrom, the object picking unit may be configured to segment the object region, and detect the object based on the segmented object region and the received object masking image.

In an exemplary embodiment, 1) when multiple object masking images are included in the original image, the receiving unit may be configured to receive a sprite image in which at least two object masking images are combined, or 2) when the original image is continuous multiple images, the receiving unit may be configured to receive a sprite image in which object masking images for a same object included in each original image are combined.

A method for transmitting an image in which an object can be picked based on view-direction according to an exemplary embodiment of the present disclosure includes extracting, by a transmitting device, an object region including an object from an original image, generating, by the transmitting device, an object masking image of the extracted object region, extracting, by the transmitting device, coordinate information of the object region in the original image, and providing, by the transmitting device, a playing device with the original image, the object masking image, and the coordinate information.

In an exemplary embodiment, the method for transmitting an image in which an object can be picked based on view-direction may further include generating, by the transmitting device, 1) a sprite image in which at least two object masking images are combined, when multiple object masking images are included in the original image, or 2) a sprite image in which object masking images for a same object included in each original image are combined, when the original image is continuous multiple images, and providing the playing device with the sprite image.

In an exemplary embodiment, the object masking image may be an image in which the object is separated from a background, and which has lower resolution than the original image.

A method for playing an image in which an object can be picked based on view-direction according to an exemplary embodiment of the present disclosure includes receiving, by an image playing device, an original image, an object masking image of at least one object region included in the original image and coordinate information of the object region in the original image, displaying, by the image playing device, the received original image, detecting, by the image playing device, view-direction of a user viewing the displayed original image, and picking, by the image playing device, the object in the displayed original image based on the detected user's view-direction, the coordinate information, and the object masking image.

In an exemplary embodiment, when the detected user's view-direction faces toward the object in the displayed original image or its surrounding, the picking may include picking the object by comparing the object directed from the user's view-direction with the object masking image.

In an exemplary embodiment, the method for playing an image in which an object can be picked based on view-direction may further include calculating, by the image playing device, a change value of the object region in a current original image by comparing an original image of a previous frame with an original image of a current frame, and the change value may be associated with at least one of translation, scale, and rotation of the object region, and the picking may include correcting the coordinate information of the object region based on the change value.

According to an aspect of the present disclosure, it is possible to smoothly play a high-quality wide view angle image and pick an object included therein by using a masking image of lower quality with lower throughput than an original image.

The effects of the present disclosure are not limited to those mentioned above, and another effect not mentioned will be clearly understood by those skilled in the art from the appended claims.

### BRIEF DESCRIPTION OF THE DRAWINGS

FIG. 1 is a block diagram of a system for picking an object based on view-direction according to an exemplary embodiment of the present disclosure.

FIG. 2 shows an original image according to an exemplary embodiment of the present disclosure.

FIGS. 3A and 3B show an object masking image generated according to an exemplary embodiment of the present disclosure.

FIG. 4 shows an image 100′ displayed on a playing device 20 according to an exemplary embodiment of the present disclosure and user view-direction a1, a2.

FIG. 5 is a flowchart of a method for transmitting an image in which an object can be picked based on view-direction according to an exemplary embodiment of the present disclosure.

FIG. 6 is a flowchart of a method for playing an image in which an object can be picked based on view-direction according to an exemplary embodiment of the present disclosure.

### DETAILED DESCRIPTION

Hereinafter, exemplary embodiments of the present disclosure will be described in detail with reference to the accompanying drawings.

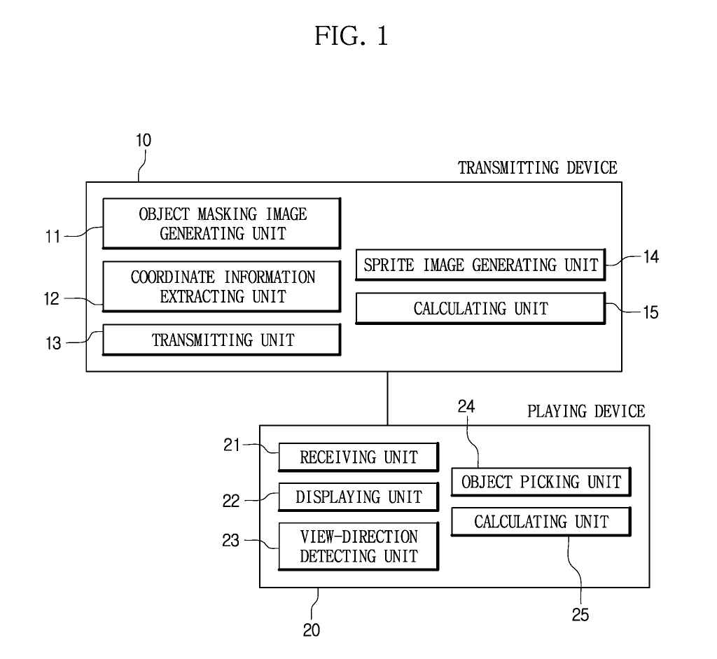

FIG. 1 is a block diagram of a system for picking an object based on view-direction according to an exemplary embodiment of the present disclosure.

Referring to FIG. 1, the system for picking an object based on view-direction according to this exemplary embodiment includes a transmitting device 10 configured to extract an object region including an object from an original image, and transmit an object masking image of the extracted object region and the original image, and a playing device 20 configured to receive the object masking image and the original image from the transmitting device, display the original image, and pick the object in the displayed original image based on view-direction of a user viewing the displayed original image. In the system for picking an object based on view-direction, the playing device 20 may be at least embodied in the form of a Head-Mounted Device (HMD) that is worn on the head of the user. Here, picking refers to displaying the particular object in the image such that the object is separated from the background at least in part, or visually changing the object with various rendering effect such as glow effect processing or silhouette processing, but also selecting the object to enable the user to control.

Furthermore, in the specification, the original image may be a wide view angle image, and preferably may be a 360-degree image, but is not limited thereto.

The system for picking an object based on view-direction according to exemplary embodiments and each device included therein may have aspects of entirely hardware, or partially hardware and partially software. For example, the system for picking an object based on view-direction, each device included therein, and each unit that constitutes each device may collectively indicate a device for processing, storing, and/or transmitting and receiving data of particular format and content and its related software. The terms “unit”, “server”, “device”, and “system” as used herein are intended to refer to a combination of hardware and software operated by the corresponding hardware. For example, the hardware may be a data processing device including a central processing unit (CPU) or another processor. Furthermore, the software operated by hardware may indicate a process being executed, an object, an executable, a thread of execution, and a program.

In an exemplary embodiment, the transmitting device 10 and the playing device 20 are configured as separate devices that can be physically distinguished from each other, and are connected via a wired and/or wireless network to allow communication between. Furthermore, the network may be a broadband network or a local area network. The transmitting device 10 may transmit original image processed-data to the playing device 20 via the network, and the playing device 20 may receive the processed data, project the original image to a coordinate system in virtual space to display it so that the user can see the original image, and pick the object included therein based on the user's view-direction.

In another exemplary embodiment, the transmitting device 10 and the playing device 20 may be incorporated into one device. For example, the transmitting device 10 and the playing device 20 may be embedded in a HMD worn on the user's head, and the transmitting device 10 and the playing device 20 may be embodied using single or multiple identical processing means (for example, microprocessor). Accordingly, although each device 10, 20 and each unit included therein are shown as separate blocks in the block diagram shown in FIG. 1, this is intended to classify the system based on the operation performed in the corresponding system, and is not necessarily intended to indicate separate elements that can be physically distinguished from each other.

In an exemplary embodiment, the transmitting device 10 includes an object masking image generating unit 11, a coordinate information extracting unit 12, and a transmitting unit 13. According to exemplary embodiments, the transmitting device 10 may further include a sprite image generating unit 14 or a calculating unit 15.

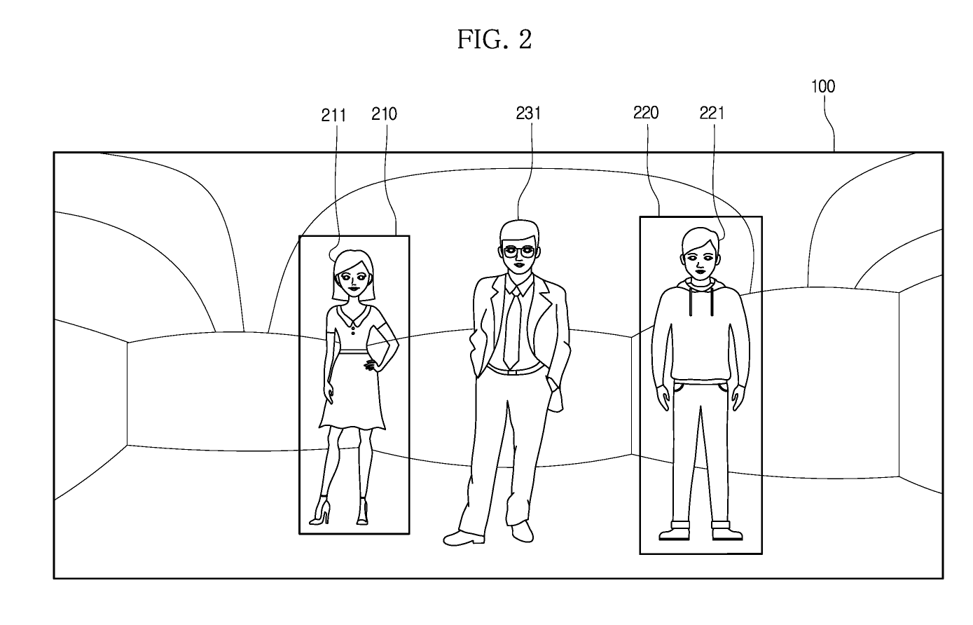

FIG. 2 shows an original image according to an exemplary embodiment of the present disclosure. The original image of FIG. 2 is an image which is taken with a 360-degree camera and displayed on a two-dimensional plane. Referring to FIG. 2, although a plurality of objects 211, 221, 231 is included in the original image 100, it is shown that object regions 210, 220 are only set for the particular objects 211, 221. The object masking image generating unit 11 is configured to extract the object regions 210, 220 including the objects from the original image 100. The range of the object regions 210, 220 may be set by user input. Although FIG. 2 shows that the object region image is rectangular, various shapes including circular, triangle or freely defined arbitrary shapes are available.

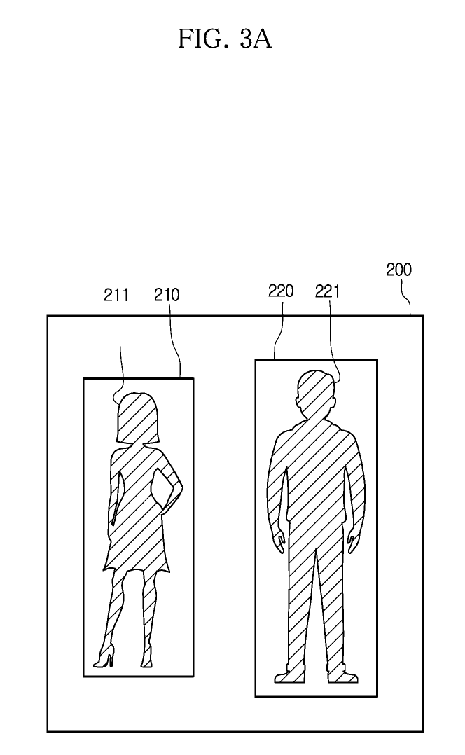

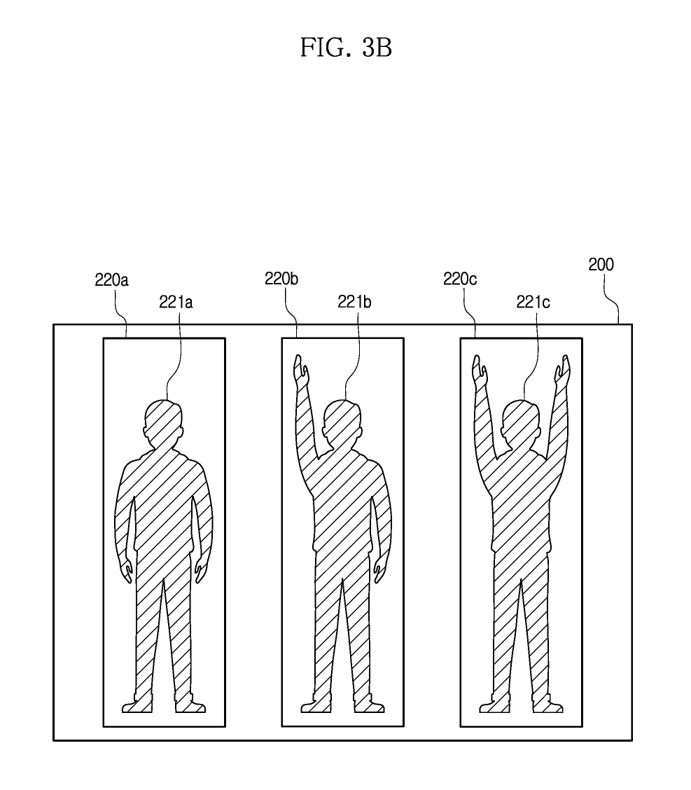

The object masking image generating unit 11 may generate an object masking image, in which the object are separated from the background, using the extracted object region. FIGS. 3A and 3B show the object masking image generated according to an exemplary embodiment of the present disclosure. The object masking image may be an image having lower resolution than the original image. The use of the low-resolution object masking image can effectively reduce load required to pick the object included in the high-resolution original image while playing the original image. Furthermore, in an exemplary embodiment, because there may be a playback range in which a change in object is not great, in order to reduce the throughput for image processing, the object masking image generating unit 11 may generate object masking images for each key frame by detecting a change in the object region. In this case, the coordinate information extracting unit 12 described below may extract the object region coordinates only for the key frame.

The coordinate information extracting unit 12 may extract coordinate information of the object regions 210, 220 in the original image. When the original image is displayed on the playing device later, the coordinate information may be used to calculate the location of the object region.

Referring to FIGS. 2 and 3A, this is a case in which multiple object regions are extracted. When multiple object regions are present in the original image, the sprite image generating unit 14 may be configured to generate a sprite image 200 in which object masking images of at least two object regions are combined. Referring to FIG. 3A, the sprite image 200 is shown, in which two different object regions 210, 220 are combined.

Referring to FIGS. 2 and 3B, this is a case in which object regions for a same object in original images of different frames are extracted. When the original image is continuous multiple images, the sprite image generating unit 14 may generate a sprite image 200 in which object masking images 220a, 220b, 220c for the same object 221; 221a, 221b, 221c included in each original image are combined. In FIG. 3B, each of the object masking image 220a, 220b, 220c may represent an object masking image for the object 221 included in the continuous original images or the original images for each key frame.

Referring to FIGS. 3A and 3B, the sprite image generating unit 14 may generate a sprite image including a plurality of different objects for each frame (FIG. 3A), and may generate a sprite image for different frames per object (FIG. 3B).

Going into further details of the case of FIG. 3B, for example, when the number of frames in the original image is 1024, 1024 first object masking images for a first object may be generated. When the resolution of the first object masking image is set to 64×64, the resolution of a first sprite image for the first object may be 2048×2048. That is, 1024 object masking images of 64×64 resolution may be included in the first sprite image.

Furthermore, when the number of frames in the original image is 4096 and an object masking image of 64×64 resolution for a first object is used, four sprite images of 2048×2048 resolution are needed. Similarly, when there is a second object, four sprite images of 2048×2048 resolution are additionally needed. Furthermore, in this case, coordinate information of each object region may be extracted as much as the number of frames.

Furthermore, before transmitting the original image, the sprite image and the object region coordinate information may be transmitted to the playing device beforehand. In an exemplary embodiment, the calculating unit 15 may be configured to calculate a change value of the object region in the current original image by comparing an original image of a previous frame with an original image of a current frame. For example, the calculated value may be associated with at least one of translation, scale, and rotation of the object region. The calculated value can facilitate the location calculation of the object region displayed in the original image when the original image is played on the playing device.

The transmitting unit 13 may transmit the original image, the object masking image (or sprite image) and the coordinate information to the playing device 20, and may further transmit the calculated value. In this instance, the object masking image (or sprite image), the coordinate information and the calculated value may be transmitted in a metadata format.

In case that the transmitting device 10 and the playing device 20 are configured as separate devices, the transmitting unit 13 may transmit the information by a transmission method via a network. However, in case that the transmitting device 10 and the playing device 20 are integrated into a same device, a transmission process by the transmitting unit 14 may signify that data is provided for use in another processor through a transitory and/or non-transitory recording medium such as memory.

The playing device 20 according to an exemplary embodiment may include a receiving unit 21, a displaying unit 22, a view-direction detecting unit 23, and an object picking unit 24. According to exemplary embodiments, the playing device 20 may further include a calculating unit 25.

The receiving unit 21 may receive the original image, the object masking image (or sprite image) and the coordinate information from the transmitting unit 13 of the transmitting device 10, and may further receive the calculated value.

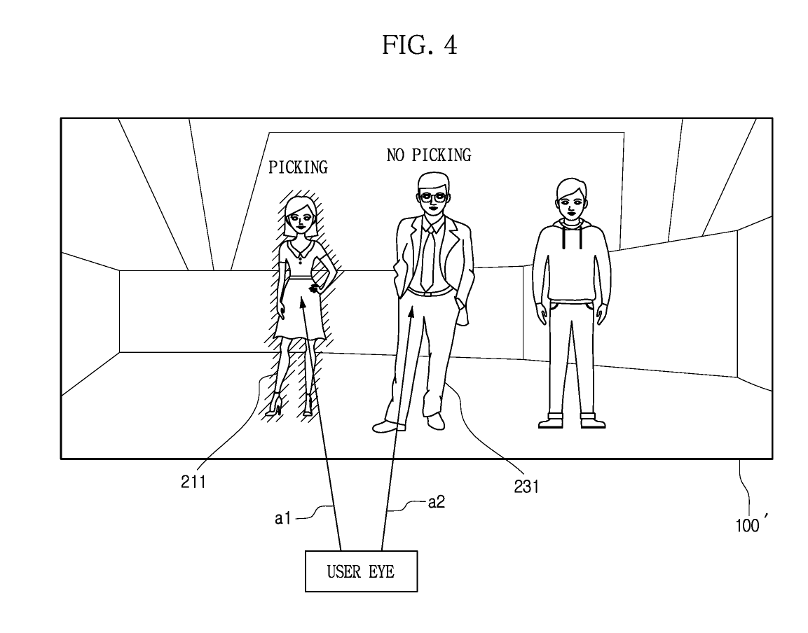

FIG. 4 shows an original image 100′ displayed on the playing device 20 according to an exemplary embodiment of the present disclosure and user view-direction a1, a2. The displaying unit 22 may display the received original image. For example, the displaying unit 22 may display the received original image by mapping the original image to a coordinate system (for example, a spherical coordinate system) in virtual space in a texture format.

The view-direction detecting unit 23 may be configured to detect the view-direction of the user viewing the displayed original image. To determine the user's view-direction, the view-direction detecting unit 23 may use various pieces of sensing information obtained from a sensor. For example, the sensor may include, but is not limited to, at least one of a gyro sensor, an acceleration sensor, an Inertial Measurement Unit (IMU) sensor, a Global Positioning System (GPS) sensor, and a vision sensor.

Referring to FIG. 4, the view-direction of the user viewing the displayed original image 100′ is shown. Specifically, each of the view-direction a1 toward the object 211 and the view-direction a2 toward the object 231 is shown.

The object picking unit 24 may be configured to pick the object in the displayed original image 100′ based on the detected user's view-direction, the coordinate information, and the object masking image. When the user's view-direction faces toward the object 211 in the original image 100′ being played or its surrounding (the range within a predetermined distance apart from the object), the object picking unit 24 may pick the object 210 by comparing the object directed from the user's view-direction with the object masking image. That is, because the object is separated from the background in the object masking image, the object 211 in the image 100′ being played may be picked such that the object 211 is separated from the background.

For example, when the detected user's view-direction is positioned in the object region or within a predetermined range therefrom, the object picking unit 24 may segment the object region, detect the object based on the segmented object region and the received object masking image, and pick the detected object. As such, image segmentation can effectively reduce image processing load.

The object picking unit 24 may pick the object in the displayed original image using the coordinate information of the object region on the coordinate system in virtual space corresponding to the original image 100 and the object masking image. That is, the object picking unit 24 may calculate the coordinates on the texture coordinate system in virtual space pointed by the user view-direction, and perform picking based on pixel information of the calculated coordinates on the texture coordinate system.

Referring to FIGS. 3 and 4, because an object region for the object 231 was not extracted, even though the user's view-direction a2 faces toward the object 231, picking does not take place. It can be seen that for the object 211 of which the object region is extracted, picking takes place when the user's view-direction a1 faces toward the object 211.

In an exemplary embodiment, the calculating unit 25 may be configured to calculate a change value of the object region in the current original image by comparing an original image of a previous frame with an original image of a current frame. The change value may be associated with at least one of translation, scale, and rotation of the object region. In this case, the object picking unit 24 may correct the coordinate information of the object region or the coordinates of the object region on the texture coordinate system in virtual space based on the change value.

The original image and the object masking image processed by the transmitting device 10 or the playing device 20 may be synchronized in time using time code information for each frame.

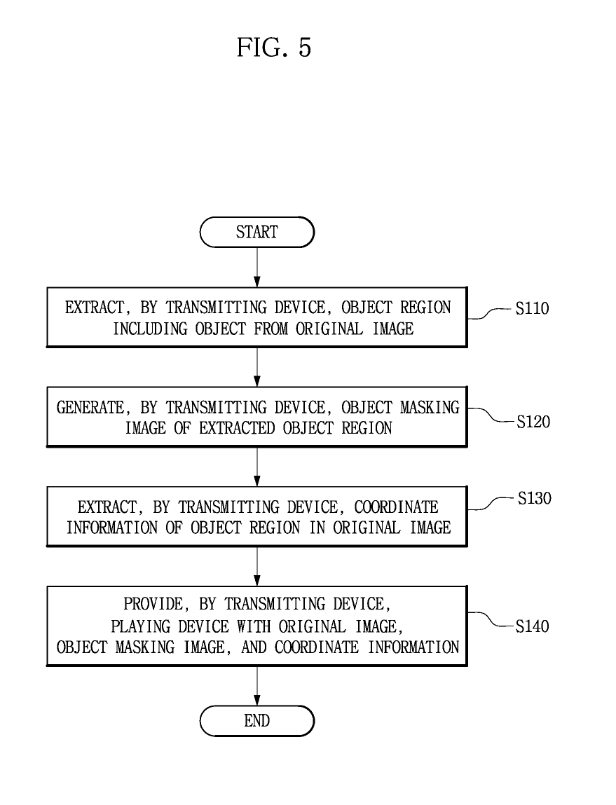

FIG. 5 is a flowchart of a method for transmitting an image in which an object can be picked based on view-direction according to an exemplary embodiment of the present disclosure. Referring to FIG. 5, the method for transmitting an image in which an object can be picked based on view-direction may include extracting, by a transmitting device, an object region including an object from an original image (S110), generating, by the transmitting device, an object masking image of the extracted object region (S120), extracting, by the transmitting device, coordinate information of the object region in the original image (S130), and providing, by the transmitting device, a playing device with the original image, the object masking image, and the coordinate information (S140).

In another exemplary embodiment, in the case of multiple object masking images, the method for transmitting an image in which an object can be picked based on view-direction may further include generating, by the transmitting device, a sprite image in which at least two object masking images are combined, and providing the playing device with the sprite image. Here, the object masking image may be an image in which the object is separated from the background, and which has lower resolution than the original image.

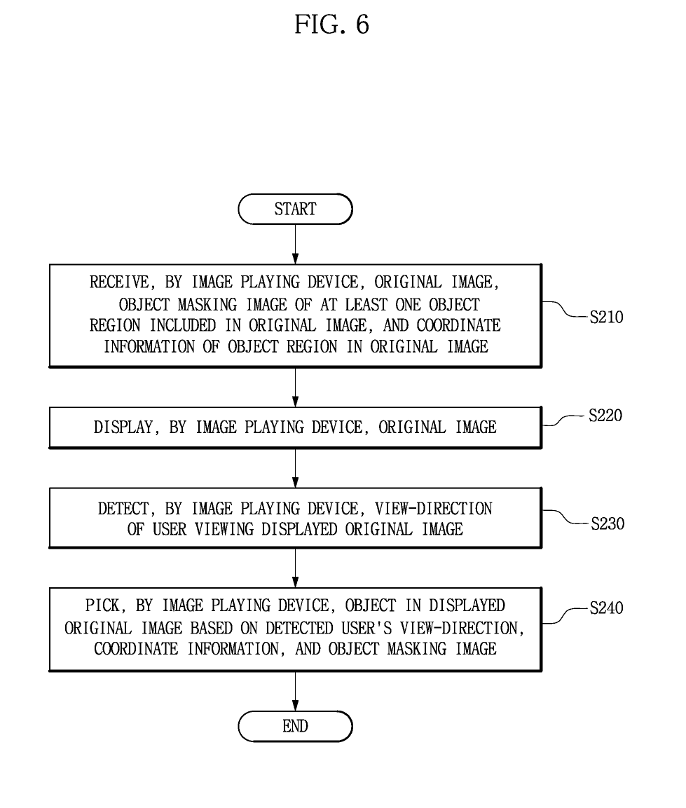

FIG. 6 is a flowchart of a method for playing an image in which an object can be picked based on view-direction according to an exemplary embodiment of the present disclosure. Referring to FIG. 6, the method for playing an image in which an object can be picked based on view-direction includes receiving, by an image playing device, an original image, an object masking image of at least one object region included in the original image, and coordinate information of the object region in the original image (S210), displaying, by the image playing device, the original image (S220), detecting, by the image playing device, view-direction of a user viewing the displayed original image (S230), and picking, by the image playing device, the object in the displayed original image based on the detected user's view-direction, the coordinate information, and the object masking image (S240). When the detected user's view-direction faces toward the object in the displayed original image or its surrounding, the picking (S240) may include picking the object in the object region image by comparing the object directed from the user's view-direction with the object masking image.

Furthermore, the method for playing an image in which an object can be picked based on view-direction may further include calculating, by the image playing device, a change value of the object region in the current original image by comparing an original image of a previous frame with an original image of a current frame. In this case, the picking (S240) may correct the coordinate information of the object region based on the change value.

Through the foregoing process, it is possible to overcome the limit of resolution resulting from the limit of decoding as in conventional devices, and pick an object in a wide view angle image with ultra high resolution, for example, 11k, while playing the image.

The methods for transmitting and playing a wide view angle image according to the exemplary embodiments as described hereinabove may be implemented, at least in part, as a computer program and recorded in a computer-readable recording medium. The computer-readable recording medium includes any type of recording device in which computer-readable data is stored. Examples of the computer-readable recording medium include ROM, RAM, CD-ROM, magnetic tape, floppy disks, and optical data storage devices. Furthermore, the computer-readable recording medium may be distributed over computer systems connected via a network, to store and execute computer-readable codes in a distribution fashion. Additionally, functional programs, codes and code segments for implementing this exemplary embodiment will be easily understood by persons having ordinary skill in the technical field to which this exemplary embodiment belongs.

While the present disclosure has been described hereinabove with reference to the exemplary embodiments shown in the drawings, this is for illustration only, and persons having ordinary skill in the art will understand that various modifications and variations could be made thereto. However, it should be noted that such modifications and variations fall within the technical scope of protection of the present disclosure. Therefore, the true technical scope of protection of the present disclosure shall be defined by the technical spirit of the appended claims.

What is claimed is:

1. A system for picking an object based on view-direction, comprising:
a transmitting device configured to extract an object region including an object from an original image, and transmit an object masking image of the extracted object region and the original image; and
a playing device configured to receive the object masking image and the original image from the transmitting device, display the original image, and pick the object in the displayed original image based on view-direction of a user viewing the original image.

2. The system for picking an object based on view-direction according to claim 1, wherein the transmitting device is configured to further extract coordinate information of the object region in the original image, and
the playing device is configured to receive the coordinate information from the transmitting device, and pick the object in the displayed original image based on the user's view-direction and the coordinate information.

3. The system for picking an object based on view-direction according to claim 1, wherein the object masking image is an image in which the object is separated from a background, and which has lower resolution than the original image.

4. A device for transmitting an image in which an object can be picked based on view-direction, comprising:
an object masking image generating unit configured to extract an object region including an object from an original image, and generate an object masking image of the extracted object region;
a coordinate information extracting unit configured to extract coordinate information of the object region in the original image; and
a transmitting unit configured to provide a playing device with the original image, the object masking image, and the coordinate information.

5. The device for transmitting an image in which an object can be picked based on view-direction according to claim 4, further comprising:
a sprite image generating unit configured to 1) generate a sprite image in which at least two object masking images are combined, when multiple object masking images are included in the original image, or 2) to generate a sprite image in which object masking images for a same object included in each original image are combined, when the original image is continuous multiple images,
wherein the transmitting unit is configured to provide the playing device with the sprite image.

6. The device for transmitting an image in which an object can be picked based on view-direction according to claim 4, wherein the object masking image is an image in which the object is separated from a background, and which has lower resolution than the original image.

7. The device for transmitting an image in which an object can be picked based on view-direction according to claim 4, further comprising:
a calculating unit configured to calculate a change value of the object region in a current original image by comparing an original image of a previous frame with an original image of a current frame,
wherein the transmitting unit is configured to transmit, to the playing device, the change value in place of or together with the coordinate information, and
the change value is associated with at least one of translation, scale, and rotation of the object region.

8. A device for playing an image in which an object can be picked based on view-direction, comprising:
a receiving unit configured to receive an original image, an object masking image of at least one object region included in the original image, and coordinate information of the object region in the original image;
a displaying unit configured to display the received original image;
a view-direction detecting unit configured to detect view-direction of a user viewing the displayed original image; and
an object picking unit configured to pick the object in the displayed original image based on the detected user's view-direction, the coordinate information, and the object masking image.

9. The device for playing an image in which an object can be picked based on view-direction according to claim 8, wherein when the detected user's view-direction faces toward the object in the displayed original image or its surrounding, the object picking unit is configured to pick the object by comparing the object directed from the user's view-direction with the object masking image.

10. The device for playing an image in which an object can be picked based on view-direction according to claim 8, wherein the object picking unit is configured to calculate texture coordinate information of the object region on a coordinate system in virtual space corresponding to the original image based on the coordinate information, and pick the object based on the calculated texture coordinate information.

11. The device for playing an image in which an object can be picked based on view-direction according to claim 8, further comprising:
a calculating unit configured to calculate a change value of the object region in a current original image by comparing an original image of a previous frame with an original image of a current frame, wherein the change value is associated with at least one of translation, scale, and rotation of the object region, and
the object picking unit is configured to correct the coordinate information of the object region based on the change value.

12. The device for playing an image in which an object can be picked based on view-direction according to claim 9, wherein when the detected user's view-direction is positioned in the object region or within a predetermined range therefrom, the object picking unit is configured to segment the object region, and detect the object based on the segmented object region and the received object masking image.

13. The device for playing an image in which an object can be picked based on view-direction according to claim 8, wherein 1) when multiple object masking images are included in the original image, the receiving unit is configured to receive a sprite image in which at least two object masking images are combined, or 2) when the original image is continuous multiple images, the receiving unit is configured to receive a sprite image in which object masking images for a same object included in each original image are combined.

14. A method for transmitting an image in which an object can be picked based on view-direction, comprising:
extracting, by a transmitting device, an object region including an object from an original image;
generating, by the transmitting device, an object masking image of the extracted object region;
extracting, by the transmitting device, coordinate information of the object region in the original image; and
providing, by the transmitting device, a playing device with the original image, the object masking image, and the coordinate information.

15. The method for transmitting an image in which an object can be picked based on view-direction according to claim 14, further comprising:
generating, by the transmitting device, 1) a sprite image in which at least two object masking images are combined, when multiple object masking images are included in the original image, or 2) a sprite image in which object masking images for a same object included in each original image are combined, when the original image is continuous multiple images; and
providing the playing device with the sprite image.

16. The method for transmitting an image in which an object can be picked based on view-direction according to claim 14, wherein the object masking image is an image in which the object is separated from a background, and which has lower resolution than the original image.

17. A method for playing an image in which an object can be picked based on view-direction, comprising:
receiving, by an image playing device, an original image, an object masking image of at least one object region included in the original image, and coordinate information of the object region in the original image;
displaying, by the image playing device, the received original image;
detecting, by the image playing device, view-direction of a user viewing the displayed original image; and
picking, by the image playing device, the object in the displayed original image based on the detected user's view-direction, the coordinate information, and the object masking image.

18. The method for playing an image in which an object can be picked based on view-direction according to claim 17, wherein when the detected user's view-direction faces toward the object in the displayed original image or its surrounding, the picking comprises picking the object by comparing the object directed from the user's view-direction with the object masking image.

19. The method for playing an image in which an object can be picked based on view-direction according to claim 17, further comprising:
calculating, by the image playing device, a change value of the object region in a current original image by comparing an original image of a previous frame with an original image of a current frame, wherein the change value is associated with at least one of translation, scale, and rotation of the object region, and
the picking comprises correcting the coordinate information of the object region based on the change value.
